(19) United States
(12) Patent Application Publication
(10) Pub. No.: US 2023/0253640 A1
(43) Pub. Date: Aug. 10, 2023

(54) METHOD FOR REGENERATING SECONDARY BATTERY

(71) Applicant: Ming-Tung SHEN, New Taipei City (TW)

(72) Inventor: Ming-Tung SHEN, New Taipei City (TW)

(21) Appl. No.: 18/165,060

(22) Filed: Feb. 6, 2023

(30) Foreign Application Priority Data
Feb. 7, 2022 (CN) 202210116452.0

(51) Int. Cl. H01M 10/54; H01M 10/0525; H01M 10/42

(52) U.S. Cl. CPC H01M 10/54; H01M 10/0525; H01M 10/4242

(57) ABSTRACT

A method for regenerating a secondary battery is disclosed and includes a discharge step before drilling, wherein the secondary battery is discharged so that no current is generated between two electrodes; a drilling step, wherein the secondary battery is drilled from an electrode terminal towards an internal direction of the secondary battery until passing through a spacer inside the secondary battery to form a drilled hole in the spacer; a solution replenishing step, wherein a solution injection needle is used to pass through the drilled hole to inject internally to the secondary battery with a supplemental electrolyte solution and the injection pressure of the supplemental electrolyte solution injected is greater than the internal pressure inside the secondary battery; and a sealing step, wherein the solution injection needle is withdrawn from the drilled hole and a sealant is applied to the drilled hole until the sealant is cured and solidified.

### BACKGROUND OF THE INVENTION

### 1. Field of the Invention

The present invention relates to a method for repairing a secondary battery, in particular a method for regenerating a secondary battery that uses an electrolyte of lithium ions, in which the secondary battery is restored to a serviceable state.

### 2. Description of the Prior Art

A secondary battery is a reusable battery obtained by discharging followed by a charging process. There are many different types of secondary batteries in the market, such as lead-acid batteries, nickel-hydrogen batteries, lithium-ion batteries, and nickel-cadmium batteries. Because of their small size and high energy density per unit, lithium-ion batteries are the most widely used. In addition, lithium-ion batteries can be manufactured in cylindrical or flat rectangle shapes and are suitable for a variety of electronic products.

However, all secondary batteries are subject to ageing and loss of function, mainly due to changes in internal materials, and lithium-ion batteries are no exception. For lead-acid batteries, the battery performance can be restored and battery life can be extended by injecting a repair solution. However, unlike lead-acid batteries, it is difficult to replenish the electrolytic solution that is gradually dried or to fill in the repair solution for lithium-ion batteries due to the integrity of the package and the flammability of the material in the lithium-ion batteries.

Chinese invention patent application of publication No. CN 110400983 A disclosed a method for regenerating a retired lithium-ion secondary battery, wherein said method comprises the following steps: A) a discharge step, wherein said retired lithium-ion secondary batteries are completely discharged; B) a cleaning and screening step, wherein the battery cores of said batteries that are completely discharged in step A) are cleaned with a cleaning solution under a dry environment until they are cleaned completely, and intact battery cores are selected; C) a drying step, the intact battery cores obtained in step B are dried; D) an electrolytic solution injection step, the intact battery cores are injected with an electrolytic solution; E) an in-situ lithium replenishment step, the anodes are replenished with lithium, and regenerated battery cores are obtained; (F) an encapsulating step, wherein the battery cores obtained in step E are re-encapsulated to obtain lithium-ion secondary batteries. This is a very dangerous way to restore the original function of the battery cores by cleaning, and the electrode materials may easily, spontaneously combust (or even explode) when exposed to air. In addition, the lithium dendrites in the battery cores cannot be removed after cleaning, and other physical methods must be used to have a chance to reduce their numbers of existence.

At present, human beings are facing a major crisis of environmental change, and the development of clean energies is a road of no return. For these clean energies, effective storage of some of these energies is also an important means to promote clean energy. In addition to the traditional reliance on reservoir regulation as a method of electricity storage, the usage of secondary battery banks to store energy is more effective and consumes less energy. However, this requires numerous secondary batteries. On the other hand, if the old secondary batteries cannot be efficiently recycled or disassembled, they will be another harm to the natural environment. Consequently, the present invention is proposed to resolve the above issues.

### SUMMARY OF THE INVENTION

Some of the features of the present invention are extracted and compiled herein. Other features will be disclosed in subsequent paragraphs. The purpose of these paragraphs is to cover various modifications and similar arrangements in the spirit and scope of the appended patent claims.

To solve the aforementioned issues, the present invention provides a method for regenerating a secondary battery. The method is for a secondary battery having a degraded electrical capacity of an electrolyte of lithium ions and comprises a discharge step before drilling, wherein the secondary battery is discharged so that no current is generated between two electrodes when said two electrodes are electrically connected; a drilling step, wherein the secondary battery is drilled from an electrode terminal towards an internal direction of the secondary battery until passing through a spacer inside the secondary battery to form a drilled hole in the spacer; a solution replenishing step, wherein a solution injection needle is used to pass through the drilled hole to inject internally to the secondary battery with a supplemental electrolyte solution and an injection pressure of the supplemental electrolyte solution injected is greater than an internal pressure inside the secondary battery; and a sealing step, wherein the solution injection needle is withdrawn from the drilled hole and a sealant is applied to the drilled hole until the sealant is cured and solidified.

The present invention also provides another method for regenerating a secondary battery. The method is also for a secondary battery having a degraded electrical capacity of an electrolyte of lithium ions and comprises a discharge step before drilling, wherein the secondary battery is discharged so that no current is generated between two electrodes when said two electrodes are electrically connected; a drilling step, wherein a surface of an electrode terminal of the secondary battery is drilled to form an opening penetrating the electrode terminal, and a solution injection needle is used to pass through the opening and jab into a spacer inside the secondary battery to penetrate the spacer; a solution replenishing step, wherein the secondary battery is injected internally with a supplemental electrolyte solution by the solution injection needle and an injection pressure of the supplemental electrolyte solution injected is greater than an internal pressure inside the secondary battery; and a sealing step, wherein the solution injection needle is withdrawn and a sealant is applied to the opening until the sealant is cured and solidified.

In the aforementioned methods for regenerating a secondary battery, before the discharge step before drilling or after the sealing step, the methods further comprise a recharge step, wherein the secondary battery is charged in a manner of a gradually decreasing electric current and a continuous or intermittent high current is applied to the secondary battery at the time of initial charging and before completion of charging to remove lithium dendrites from electrode material plates for the first time; and a lithium dendrite removal and discharge step, wherein the secondary battery is discharged in a manner of a gradually increasing electric current and the secondary battery is discharged by a continuous or intermittent high current at the time of initial discharging and before completion of discharging to remove lithium dendrites from the electrode material plates for the second time.

In the aforementioned methods for regenerating a secondary battery, the drilling step and the solution replenishing step can be performed in a vacuum environment, and the solution injection needle isolates the supplemental electrolyte solution and internal materials of the secondary battery from the vacuum environment outside.

In the aforementioned methods for regenerating a secondary battery, the methods may further comprise a testing step, wherein the secondary battery is placed in a non-conducting liquid, and if no air bubbles occur from a sealed position where the drilled hole or opening that has been sealed with the sealant, the secondary battery is qualified.

In the aforementioned methods for regenerating a secondary battery, the high current is less than 1000 times an electric current when the secondary battery is discharged or charged.

In the aforementioned methods for regenerating a secondary battery, the intermittent high current may form a pulse current.

In the aforementioned methods for regenerating a secondary battery, the drilling step is preferably performed by simultaneously sucking or blowing powder particles generated out of the drilled hole or opening.

In the aforementioned methods for regenerating a secondary battery, the supplemental electrolyte solution may be further supplemented with microelements of less than 100000 PPM. The microelements are nickel, zinc, lithium, cobalt, sodium, niobium, carbon or silicon particles with a size below micron or oxides of the aforementioned substances.

In the aforementioned methods for regenerating a secondary battery, the supplemental electrolyte solution is injected in an amount of at least 0.1 cc.

In the aforementioned methods for regenerating a secondary battery, the sealing step may further use a glue syringe to apply the sealant to the drilled hole or opening.

In addition, the present invention provides a method for regenerating a secondary battery having a degraded electrical capacity of an electrolyte of lithium ions, and the method comprises
a discharge step before drilling, wherein the secondary battery is discharged so that no current is generated between two electrodes when said two electrodes are electrically connected;
a drilling step, wherein the secondary battery is drilled from an electrode terminal towards an internal direction of the secondary battery until passing through a spacer inside the secondary battery to form a drilled hole in the spacer;
a step of lithium dendrite removal by solution, wherein the secondary battery with the drilled hole is immersed in an acid solution that dissolves the lithium dendrites and the lithium dendrites are removed from electrode material plates with the aid of an ultrasonic wave to dissolve the lithium dendrites, and then the acid solution is discarded;
a solution replenishing step, wherein a solution injection needle is used to pass through the drilled hole to inject internally to the secondary battery with a supplemental electrolyte solution and the injection pressure of the supplemental electrolyte solution injected is greater than the internal pressure inside the secondary battery; and
a sealing step, wherein the solution injection needle is withdrawn from the drilled hole and a sealant is applied to the drilled hole until the sealant is cured and solidified.

Further, the present invention provides a method for regenerating a secondary battery having a degraded electrical capacity of an electrolyte of lithium ions, and the method comprises
a discharge step before drilling, wherein the secondary battery is discharged so that no current is generated between two electrodes when said two electrodes are electrically connected;
a drilling step, wherein the secondary battery is drilled from an electrode terminal towards an internal direction of the secondary battery until passing through a spacer inside the secondary battery to form a drilled hole in the spacer;
a step of lithium dendrite removal by magnetic nanoparticles, wherein a nanomagnetic fluid is added from the drilled hole and a magnetic field is used to move the magnetic nanoparticles in the nanomagnetic fluid to remove lithium dendrites from electrode material plates, and then the nanomagnetic fluid is discarded;
a solution replenishing step, wherein a solution injection needle is used to pass through the drilled hole to inject internally to the secondary battery with a supplemental electrolyte solution and the injection pressure of the supplemental electrolyte solution injected is greater than the internal pressure inside the secondary battery; and
a sealing step, wherein the solution injection needle is withdrawn from the drilled hole and a sealant is applied to the drilled hole until the sealant is cured and solidified.

Further, the present invention provides a method for regenerating a secondary battery having a degraded electrical capacity of an electrolyte of lithium ions, and the method comprises
a discharge step before drilling, wherein the secondary battery is discharged so that no current is generated between two electrodes when said two electrodes are electrically connected;
a drilling step, wherein the secondary battery is drilled from an electrode terminal towards an internal direction of the secondary battery until passing through a spacer inside the secondary battery to form a drilled hole in the spacer;
a step of lithium dendrite removal by solution, wherein an acid solution or an alkaline solution that dissolves lithium dendrites is added from the drilled hole and an ultrasonic wave is used to assist the removal of the lithium dendrites from electrode material plates, and then the acid solution or the alkaline solution is discarded;
a lithium dendrite removal testing step, wherein residue of the lithium dendrites is inspected, and if the residue of the lithium dendrites is detected, the step of lithium dendrite removal by solution is repeated, otherwise proceed to the next step;
a solution replenishing step, wherein a solution injection needle is used to pass through the drilled hole to inject internally to the secondary battery with a supplemental electrolyte solution and an injection pressure of the supplemental electrolyte solution is greater than an internal pressure inside the secondary battery; and
a sealing step, wherein the solution injection needle is withdrawn from the drilled hole and a sealant is applied to the drilled hole until the sealant is cured and solidified.

Further, the present invention provides a method for regenerating a secondary battery having a degraded electrical capacity of an electrolyte of lithium ions, and the method comprises
a discharge step before drilling, wherein the secondary battery is discharged so that no current is generated between two electrodes when said two electrodes are electrically connected;
a drilling step, wherein the secondary battery is drilled from an electrode terminal towards an internal direction of the secondary battery until passing through a spacer inside the secondary battery to form a drilled hole in the spacer;
a step of lithium dendrite removal by magnetic nanoparticles, wherein a nanomagnetic fluid is added from the drilled hole and a magnetic field is used to move the magnetic nanoparticles in the nanomagnetic fluid to remove lithium dendrites from electrode material plates, and then the nanomagnetic fluid is discarded;
a lithium dendrite removal testing step, wherein residue of the lithium dendrites is inspected, and if the residue of the lithium dendrites is detected, the step of lithium dendrite removal by magnetic nanoparticles is repeated, otherwise proceed to the next step;
a solution replenishing step, wherein a solution injection needle is used to pass through the drilled hole to inject internally to the secondary battery with a supplemental electrolyte solution and an injection pressure of the supplemental electrolyte solution is greater than an internal pressure inside the secondary battery; and
a sealing step, wherein the solution injection needle is withdrawn from the drilled hole and a sealant is applied to the drilled hole until the sealant is cured and solidified.

Further, the present invention provides a method for regenerating a secondary battery having a degraded electrical capacity of an electrolyte of lithium ions, and the method comprises
a discharge step before drilling, wherein the secondary battery is discharged so that no current is generated between two electrodes when said two electrodes are electrically connected;
a drilling step, wherein the secondary battery is drilled from an electrode terminal towards an internal direction of the secondary battery until passing through a spacer inside the secondary battery to form a drilled hole in the spacer;
a step of lithium dendrite removal by ultra-high pressure supercritical oscillation, wherein a cleaning solution is added from the drilled hole and lithium dendrites are removed from electrode material plates under an ultra-high pressure supercritical condition by oscillation, and then the cleaning solution is discarded;
a lithium dendrite removal testing step, wherein residue of the lithium dendrites is inspected, and if the residue of the lithium dendrites is detected, the step of lithium dendrite removal by ultra-high pressure supercritical oscillation is repeated, otherwise proceed to the next step;
a solution replenishing step, wherein a solution injection needle is used to pass through the drilled hole to inject internally to the secondary battery with a supplemental electrolyte solution and an injection pressure of the supplemental electrolyte solution is greater than an internal pressure inside the secondary battery; and
a sealing step, wherein the solution injection needle is withdrawn from the drilled hole and a sealant is applied to the drilled hole until the sealant is cured and solidified.

Further, the present invention provides a method for regenerating a secondary battery having a degraded electrical capacity of an electrolyte of lithium ions, and the method comprises
a discharge step before drilling, wherein the secondary battery is discharged so that no current is generated between two electrodes when said two electrodes are electrically connected;
a drilling step, wherein the secondary battery is drilled from an electrode terminal towards an internal direction of the secondary battery until passing through a spacer inside the secondary battery to form a drilled hole in the spacer;
an automated lithium dendrite removal step, wherein a sufficient amount of a cleaning solution is added from the drilled hole by an automated equipment, and the automated equipment automatically removes lithium dendrites from electrode material plates using the cleaning solution, and then the cleaning solution is discarded;
a lithium dendrite removal testing step, wherein residue of the lithium dendrites is inspected, and if the residue of the lithium dendrites is detected, the automated lithium dendrite removal step is repeated, otherwise proceed to the next step;
a drying step, wherein the secondary battery is dried;
a solution replenishing step, wherein a solution injection needle is used to pass through the drilled hole to inject internally to the secondary battery with a supplemental electrolyte solution and an injection pressure of the supplemental electrolyte solution is greater than an internal pressure inside the secondary battery; and
a sealing step, wherein the solution injection needle is withdrawn from the drilled hole and a sealant is applied to the drilled hole until the sealant is cured and solidified.

Further, the present invention provides a method for regenerating a secondary battery having a degraded electrical capacity of an electrolyte of lithium ions, and the method comprises
a discharge step before drilling, wherein the secondary battery is discharged so that no current is generated between two electrodes when said two electrodes are electrically connected;
a drilling step, wherein the secondary battery is drilled from an electrode terminal towards an internal direction of the secondary battery until passing through a spacer inside the secondary battery to form a drilled hole in the spacer;
an automated lithium dendrite removal step, wherein a sufficient amount of a cleaning solution is added from the drilled hole by an automated equipment, and the automated equipment automatically removes lithium dendrites from electrode material plates using the cleaning solution, and then the cleaning solution is discarded; and wherein the automated lithium dendrite removal step can be repeated several times with different cleaning solutions;
a lithium dendrite removal testing step, wherein residue of the lithium dendrites is inspected, and if the residue of the lithium dendrites is detected, the automated lithium dendrite removal step is repeated, otherwise proceed to the next step;
a drying step, wherein the secondary battery is dried;
a solution replenishing step, wherein a solution injection needle is used to pass through the drilled hole to inject internally to the secondary battery with a supplemental electrolyte solution and an injection pressure of the supplemental electrolyte solution is greater than an internal pressure inside the secondary battery; and
a sealing step, wherein the solution injection needle is withdrawn from the drilled hole and a sealant is applied to the drilled hole until the sealant is cured and solidified.

Further, the present invention provides a method for regenerating a secondary battery having a degraded electrical capacity of an electrolyte of lithium ions, and the method comprises
a discharge step before drilling, wherein the secondary battery is discharged so that no current is generated between two electrodes when said two electrodes are electrically connected;
a drilling step, wherein the secondary battery is drilled from an electrode terminal towards an internal direction of the secondary battery until passing through a spacer inside the secondary battery to form a drilled hole in the spacer;
an automated lithium dendrite removal step, wherein a sufficient amount of a cleaning solution is added from the drilled hole by an automated equipment, and the automated equipment automatically removes lithium dendrites from electrode material plates using the cleaning solution, and then the cleaning solution is discarded; and wherein an automated motoring module is used to monitor an internal impedance of the secondary battery, and if the internal impedance is abnormal, the automated lithium dendrite removal step is repeated, otherwise proceed to the next step;
a solution replenishing step, wherein a solution injection needle is used to pass through the drilled hole to inject internally to the secondary battery with a supplemental electrolyte solution and an injection pressure of the supplemental electrolyte solution is greater than an internal pressure inside the secondary battery; and
a sealing step, wherein the solution injection needle is withdrawn from the drilled hole and a sealant is applied to the drilled hole until the sealant is cured and solidified.

Further, the present invention provides a method for regenerating a secondary battery having a degraded electrical capacity of an electrolyte of lithium ions, and the method comprises
a discharge step before drilling, wherein the secondary battery is discharged so that no current is generated between two electrodes when said two electrodes are electrically connected;
a drilling step, wherein the secondary battery is drilled from an electrode terminal towards an internal direction of the secondary battery until passing through a spacer inside the secondary battery to form a drilled hole in the spacer;
an automated lithium dendrite removal step, wherein a sufficient amount of a cleaning solution is added from the drilled hole by an automated equipment, and the automated equipment automatically removes lithium dendrites from electrode material plates using the cleaning solution, and then the cleaning solution is discarded;
a step of detecting precipitates in the cleaning solution, wherein an automated monitoring module is used to inspect precipitates in the cleaning solution discarded, and if the precipitates are abnormal, the automated lithium dendrite removal step is repeated, otherwise proceed to the next step;
a solution replenishing step, wherein a solution injection needle is used to pass through the drilled hole to inject internally to the secondary battery with a supplemental electrolyte solution and an injection pressure of the supplemental electrolyte solution is greater than an internal pressure inside the secondary battery; and
a sealing step, wherein the solution injection needle is withdrawn from the drilled hole and a sealant is applied to the drilled hole until the sealant is cured and solidified.

Further, the present invention provides a method for regenerating a secondary battery having a degraded electrical capacity of an electrolyte of lithium ions, and the method comprises
a discharge step before drilling, wherein the secondary battery is discharged so that no current is generated between two electrodes when said two electrodes are electrically connected;
a drilling step, wherein the secondary battery is drilled from an electrode terminal towards an internal direction of the secondary battery until passing through a spacer inside the secondary battery to form a drilled hole in the spacer;
a lithium dendrite removal step, wherein a cleaning solution is added from the drilled hole and an ultrasonic wave is used to assist the removal of the lithium dendrites from electrode material plates, and then the cleaning solution is discarded;
a solution replenishing step, wherein a solution injection needle is used to pass through the drilled hole to inject internally to the secondary battery with a supplemental electrolyte solution and an injection pressure of the supplemental electrolyte solution is greater than an internal pressure inside the secondary battery; and
a sealing step, wherein the solution injection needle is withdrawn from the drilled hole, and the drilled hole is sealed with a hole plug so that the drilled hole can be reused next time in the lithium dendrite removal step for regenerating the secondary battery.

Further, the present invention provides a method for regenerating a secondary battery having a degraded electrical capacity of an electrolyte of lithium ions, and the method comprises
a discharge step before drilling, wherein the secondary battery is discharged so that no current is generated between two electrodes when said two electrodes are electrically connected;
a drilling step, wherein the secondary battery is drilled from an electrode terminal towards an internal direction of the secondary battery until passing through a spacer inside the secondary battery to form a drilled hole in the spacer;
a lithium dendrite removal step, wherein a storage tank containing a nanomagnetic fluid or an electrolyte is pre-installed in the secondary battery through the drilled hole, and the storage tank can be controlled by an external magnetic force to release and recover the nanomagnetic fluid or the electrolyte to remove lithium dendrites from electrode material plates;
a solution replenishing step, wherein a solution injection needle is used to pass through the drilled hole to inject internally to the secondary battery with a supplemental electrolyte solution and an injection pressure of the supplemental electrolyte solution is greater than an internal pressure inside the secondary battery; and
a sealing step, wherein the solution injection needle is withdrawn from the drilled hole, and the drilled hole is sealed with a hole plug so that the drilled hole can be reused next time in the lithium dendrite removal step for regenerating the secondary battery;
wherein when the drilled hole is sealed with the hole plug, the storage tank can again release and recover the nanomagnetic fluid or the electrolyte by the control of the external magnetic force to remove lithium dendrites from the electrode material plates.

The present invention uses physical means for replenishing the supplemental electrolyte solution and removes the lithium dendrites by electrochemical means, an acid solution and magnetic nanoparticles, so that the secondary battery having a degraded electrical capacity of an electrolyte of lithium ions can be quickly and effectively restored to its original performance. In addition to solving the disposal problem of waste secondary batteries, the present invention also contributes to the development and storage of clean energy.

### BRIEF DESCRIPTION OF THE DRAWINGS

The invention, as well as a preferred mode of use and advantages thereof, will be best understood by referring to the following detailed description of an illustrative embodiment in conjunction with the accompanying drawings, wherein:

FIG. 1 is a flow chart of a method for regenerating a secondary battery according to an embodiment of the present invention;

FIG. 2 is a cross-sectional view of an 18650 lithium-ion battery according to the present embodiment;

FIG. 3 is a schematic diagram of the drilling step performed on the 18650 lithium-ion battery;

FIG. 4 illustrates the 18650 lithium-ion battery after drilling;

FIG. 5 is a schematic diagram of the solution replenishing step performed on the 18650 lithium-ion battery;

FIG. 6 is a schematic diagram of the sealing step performed on the 18650 lithium-ion battery;

FIG. 7 illustrates the 18650 lithium-ion battery after the sealing step;

FIG. 8 is a schematic diagram of the 18650 lithium-ion battery receiving an electric current during the recharge step;

FIG. 9 is a schematic diagram of the 18650 lithium-ion battery discharging an electric current during the lithium dendrite removal and discharge step;

FIG. 10 is a flow chart of a method for regenerating a secondary battery according to another embodiment of the present invention;

FIG. 11 is a schematic diagram of the drilling step performed on the 18650 lithium-ion battery of FIG. 2;

FIG. 12 is a schematic diagram of the solution replenishing step performed on the 18650 lithium-ion battery of FIG. 2;

FIG. 13 to FIG. 23 are flow charts of the method for regenerating a secondary battery according to the embodiments of the present invention; and

FIG. 24 is an exploded view of a square lithium battery according to an embodiment of the present invention.

### DETAILED DESCRIPTION OF THE PREFERRED EMBODIMENTS

To better illustrate the present invention, the present invention will be described more specifically by referring to the following embodiments.

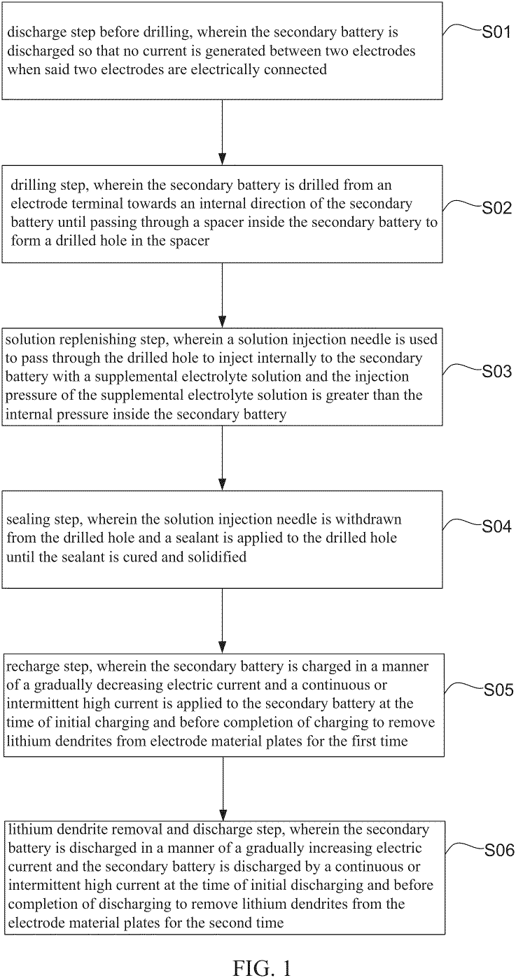

As shown in FIG. 1, FIG. 1 is a flow chart of a method for regenerating a secondary battery according to the present invention. According to the present invention, the method for regenerating a secondary battery is for a secondary battery having a degraded electrical capacity of an electrolyte of lithium ions. The aforementioned secondary battery can be round or square in shape. The aforementioned secondary battery is not limited to any encapsulation type, but can be a cylindrical secondary lithium-ion battery (such as an 18650 lithium-ion battery), a hard-shell secondary lithium-ion battery, or a soft-pack secondary lithium-ion battery. The composition structures of the aforementioned secondary batteries are also not limited, so they can be a common lithium-ion polymer battery, lithium-iron phosphate battery, lithium-titanate battery, lithium-sulfur battery, dual-carbon battery, etc. For better understanding, an 18650 lithium-ion battery is used as an example for illustration.

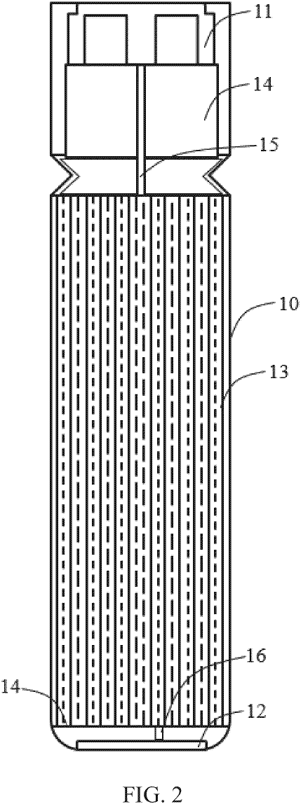

As shown in FIG. 2, FIG. 2 is a cross-sectional view of the 18650 lithium-ion battery according to the present embodiment. The main structure of the 18650 lithium-ion battery comprises an outermost case 10 for protecting the internal components of the battery, two electrode terminals (a positive electrode terminal 11 and a negative electrode terminal 12) at both ends of the case 10, a battery core 13 inside the case 10 for storing electricity, and two spacers 14 for isolating the battery core 13 from the external environment. The battery core 13 is formed by wrapping electrode material plates including positive electrode material plates (indicated by long-dashed lines) and negative electrode material plates (indicated by short-dashed lines) and separators interposed in-between (indicated by solid lines) into a column. The battery core 13 is also filled with electrolyte solution and serves as a temporary circuit between the positive electrode material plates and the negative electrode material plates during charging and discharging. In addition, the battery core 13 is connected to the positive electrode terminal 11 by a positive connection tab 15 passing through the spacer 14, and the battery core 13 is connected to the negative electrode terminal 12 by a negative connection tab 16 passing through the spacer 14. It should be noted that, for the convenience of illustration, the ratio of the positive portion in FIG. 2 (including the positive electrode terminal 11, the spacer 14 and the positive connection tab 15) is exaggeratedly enlarged in relation to the rest of the figure.

The first step in the method for regenerating the secondary battery is the discharge step before drilling, wherein the secondary battery is discharged so that no current is generated between two electrodes when said two electrodes are electrically connected (S01). If there is still electricity left in the secondary battery, the next step will easily cause internal discharge between the positive electrode material plates and the negative electrode material plates, thereby damaging the battery core 13. Therefore, the initial step has to be done exactly.

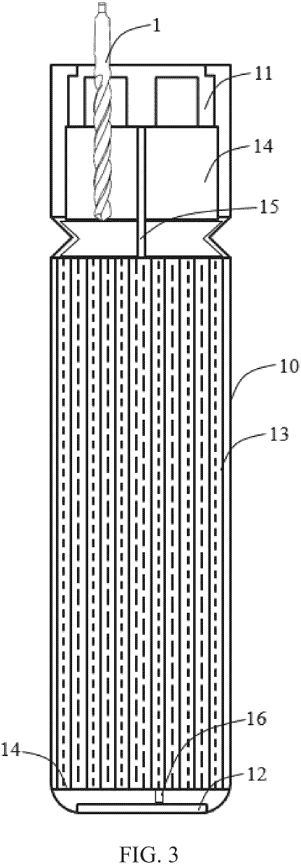

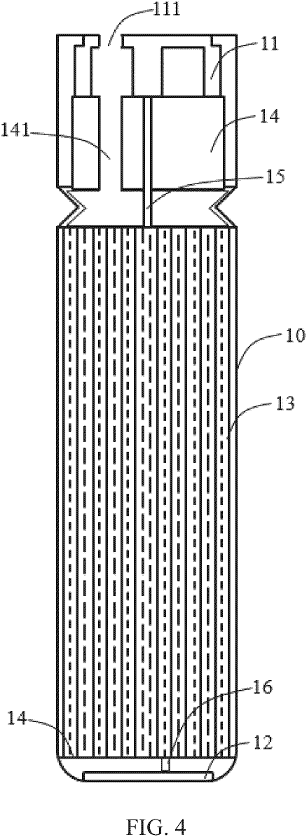

The second step in the method for regenerating the secondary battery is the drilling step, wherein the secondary battery is drilled from an electrode terminal towards an internal direction of the secondary battery until passing through a spacer inside the secondary battery to form a drilled hole in the spacer (S02). As shown in FIG. 3, FIG. 3 is a schematic diagram of the drilling step performed on the 18650 lithium-ion battery of FIG. 2. The 18650 lithium-ion battery is drilled vertically from one side of the positive electrode terminal 11 to the center of the 18650 lithium-ion battery by a drill bit 1 (which can also be drilled from one side of the negative electrode terminal 12). It should be noted that the drill bit 1 should not touch the positive connection tab 15 to avoid damage, and FIG. 4 illustrates the 18650 lithium-ion battery after drilling. In addition to a drilled hole 141 formed in the spacer 14, an opening 111 is also generated in the positive electrode terminal 11 in the drilling step. Preferably, according to the present invention, the drill bit 1 stops exactly at the end of the spacer 14, so as not to damage the materials of the battery core 13. However, since the materials and thickness of the spacer 14 used by each manufacturer are different, it is impossible to determine where to stop drilling the hole at the end of the drill bit 1. Therefore, the best practice is to use a CNC drilling machine to perform this step with the manufacturer’s standard specifications and drawings. The width of the drill bit 1 should not be too wide and should be chosen to match the solution injection needle used in the subsequent step. The outer diameters of the drill bit 1 and the solution injection needle should be the same or as close as possible. Of course, both should not be too wide relative to the external dimension of the positive electrode terminal 11, which will easily cause trouble in sealing the drilled hole 141 later.

The drilling step can have different external environments. One practice is under an environment of atmospheric pressure, and the other is in a vacuum environment. In the environment of atmospheric pressure, drill bit 1 produces a lot of powder particles during drilling. The electrode terminals are usually made of aluminum or aluminium alloys, and when the drill bit 1 rubs against the electrode terminal at high speed, the highly heated powder particles drilled out will easily burn when they come into contact with external oxygen. If the amount of the highly heated powder particles is too much, an explosion may occur. Therefore, the drilling step needs to be carried out under safe conditions. One way is to use a tool, such as a vacuum tube, to suck or blow the powder particles out of the drilled hole 141 (preferably far away from the short-circuit range between the positive electrode and negative electrode to avoid disaster caused by residual power). The powder particles flying away from the 18650 lithium-ion battery should also be collected by a good dust collection device. Preferably, fire extinguishing equipment should be placed at the site where the drilling step is performed, in case of emergency. The operation will be relatively safe if this step is performed in a vacuum environment. The powder particles drilled out will not come into contact with oxygen and will fall unhindered to the support surface, where they will be collected at the end of this step. It is important to note that after a long period of use, some gases that have not been removed or cannot be removed may accumulate in the secondary battery. Therefore, when the drilling step of the method for regenerating the secondary battery is carried out, the accumulated gas inside the secondary battery can also be simultaneously removed (for example, through the spaces between the threads of the drill bit 1), which is feasible under an environment of atmospheric pressure or a vacuum environment.

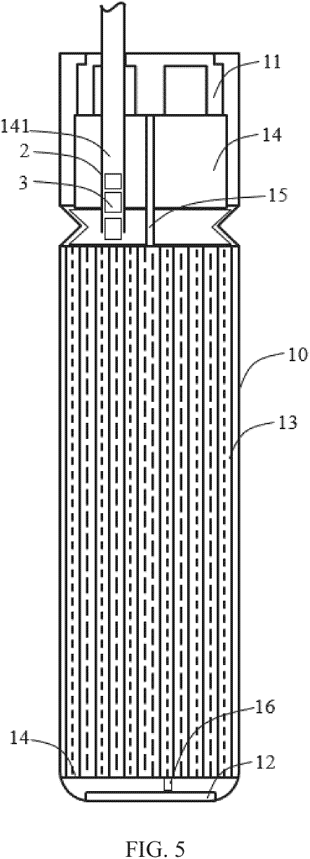

The third step of the method for regenerating the secondary battery is the solution replenishing step. In this step, a solution injection needle is used to pass through the drilled hole to inject internally to the secondary battery with a supplemental electrolyte solution, wherein the injection pressure of the supplemental electrolyte solution injected is greater than the internal pressure inside of the secondary battery (S03). As shown in FIG. 5, FIG. 5 is a schematic diagram of the solution replenishing step performed on the 18650 lithium-ion battery of FIG. 2. After the drill bit 1 is withdrawn from the drilled hole 141, a solution injection needle 2 should be inserted back into the drilled hole 141 as soon as possible to prevent the internal electrolyte solution from spraying out or the external gas from entering. By applying pressure, the supplemental electrolyte solution 3 can be injected from an external injector (not shown). The injector must apply a pressure greater than the internal pressure inside the 18650 lithium-ion battery to the supplemental electrolyte solution 3 because the internal pressure caused by the unremoved gas inside the 18650 lithium-ion battery will be transmitted by the connection of the solution injection needle 2. The ideal situation for replenishing the supplemental electrolyte solution 3 is to fill it to the amount at the time of manufacture. However, the actual condition of the electrolyte solution cannot be known, and in practice, the supplemental electrolyte solution 3 can be replenished until it overflows, or a specific volume of supplemental electrolyte solution 3 can be injected according to experience and battery model. Due to the wide variety of secondary battery models, the amount of supplemental electrolyte solution 3 for injection may range from 0.1 cc to 100 cc, but should not be less than 0.1 cc. In practice, the injection volume of the supplemental electrolyte solution 3 can be set by the computer-integrated manufacturing program to determine the amount to be injected by the injector, and a parameter table is available in the computer-integrated manufacturing software for reference and calculation. In the present embodiment, the solution replenishing step is carried out under an environment of atmospheric pressure. If the drilling step is performed in a vacuum environment, the solution replenishing step can also be performed in a vacuum environment, and the solution injection needle 2 can isolate the electrolyte solution and the internal materials of the secondary battery from the external vacuum environment.

According to the present invention, microelements can be further added to the supplemental electrolyte solution 3. Microelements can absorb water, oxygen and hydrogen in the secondary battery and reduce the generation of lithium dendrites on the electrode material plates (positive electrode material plates and negative electrode material plates) and facilitate the activation of the secondary battery. Microelements refer to particles of nickel, zinc, lithium, cobalt, sodium, niobium, carbon, silicon, or oxides of the aforementioned substances with a size below a micron (micron or nanometer scale). Since the microelements are in a trace amount, the amount of microelements to be added should be at least 1 PPM (relative to the amount of the supplemental electrolyte solution 3 injected) and at most 100,000 PPM. The amount of microelements added should depend on the condition of the secondary battery.

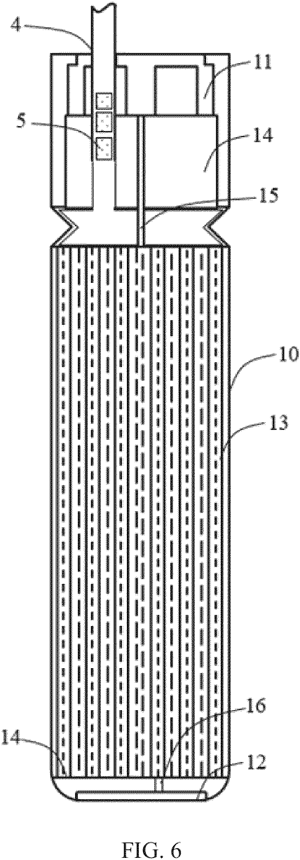

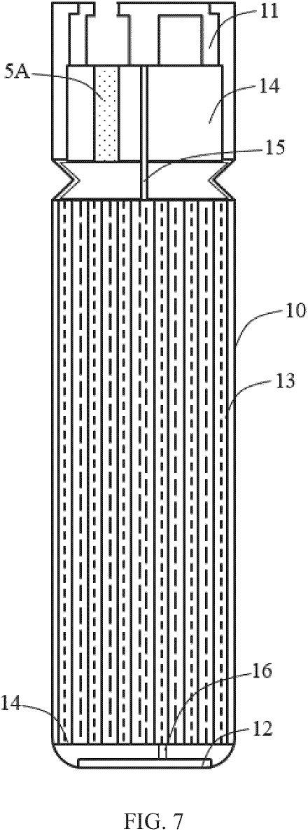

The fourth step of the method for regenerating the secondary battery is the sealing step. In this step, the solution injection needle is withdrawn from the drilled hole, and a sealant is applied to the drilled hole until the sealant is cured and solidified (S04). As shown in FIG. 6, FIG. 6 is a schematic diagram of the sealing step performed on the 18650 lithium-ion battery. According to the present invention, a glue syringe 4 can be used to apply sealant 5 to the drilled hole 141. The choice of sealant is based on the suitability for the spacer 14, such as epoxy resin. FIG. 7 illustrates the 18650 lithium-ion battery after the sealing step. At this point, the glue syringe 4 is withdrawn and the part filled with the sealant 5 forms a cured structure 5A, and the drilled hole 141 is sealed completely.

The above steps use physical means to replenish the secondary battery with electrolyte solution in a safe manner. In practice, the time for replenishing the electrolyte solution should be as short as possible to avoid the risk of external air entering the secondary battery. However, the lithium dendrites on the electrode material plates in the secondary battery have not been removed, so the following steps need to be done.

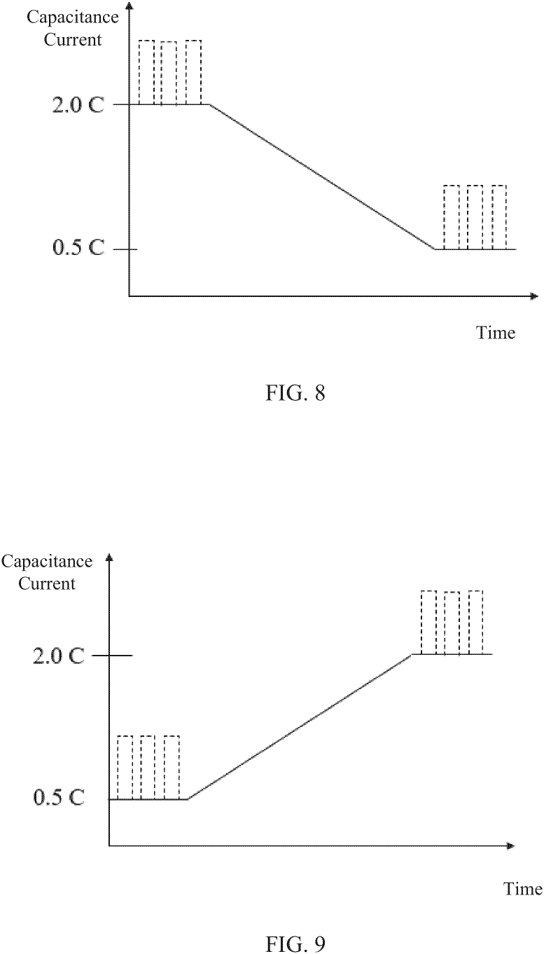

The fifth step of the method for regenerating the secondary battery is the recharge step. In this step, the secondary battery is charged in a manner of a gradually decreasing electric current, wherein a continuous or intermittent high current is applied to the secondary battery at the time of initial charging and before completion of charging to remove lithium dendrites from the electrode material plates for the first time (S05). For a better understanding, as shown in FIG. 8, FIG. 8 is a schematic diagram of the 18650 lithium-ion battery receiving an electric current during the recharge step. It should be noted that the unit used in the vertical axis is the capacitance current. In the general charging process of the 18650 lithium-ion battery, the electric current is gradually decreased from the initial charging current (higher) to the charging current at the completion of charging (lower). In fact, except for a smooth and stable period at the beginning and end of the charging process, the change in the electric current is an irregular curve. For the convenience of explanation, the entire recharging process is illustrated by three solid straight lines. According to the present invention, the continuous or intermittent high current applied to the 18650 lithium-ion battery during the initial charging and before the completion of the charging is shown in dashed lines and can be achieved by charging equipment in practice. The aforementioned high current is within 1000 times the electric current of the 18650 lithium-ion battery when it is discharged or charged, e.g., 1 C. In the case of a continuous application of high current, a sufficient additional current is applied to impact the lithium dendrites on the electrode material plates at a time, and in the case of a discontinuous application of high current, the high current forms a pulse current. The frequency of the pulse current can be adjusted according to the characteristics of different secondary batteries to achieve the best results.

The sixth step of the method for regenerating the secondary battery is the lithium dendrite removal and discharge step. In this step, the secondary battery is discharged in a manner of a gradually increasing electric current, wherein the secondary battery is discharged by a continuous or intermittent high current at the time of initial discharging and before completion of discharging to remove lithium dendrites from the electrode material plates for the second time (S06). This step is the opposite of the recharge step. This step uses the current during discharge to reversely impact and remove the lithium dendrites. As shown in FIG. 9, FIG. 9 is a schematic diagram of the 18650 lithium-ion battery discharging an electric current during the lithium dendrite removal and discharge step. Similar to FIG. 8, FIG. 9 also uses three solid straight lines to illustrate the entire process of lithium dendrite removal and discharge, along with the high current shown by the dashed lines. The definition and range of high current are as described above. In practice, the recharge step and the lithium dendrite removal and discharge step can also be done prior to the discharge step before drilling, which is also within the scope of the present invention.

It should be noted that the regulation of the release of high current of the secondary battery can be done by adjusting the resistance on the discharging equipment. The recharge step and the lithium dendrite removal and discharge step solve the lithium dendrites problem of the secondary battery by an electrochemical method. At this point, the regenerated secondary battery can be restored to approximately 10%-99% of electricity storage characteristics at the time of manufacture.

Since the completeness of the sealing step may affect the performance of the regenerated secondary battery, it is necessary to inspect the secondary battery regenerated. Therefore, the lithium dendrite removal and discharge step can be followed by a testing step, wherein the secondary battery is placed in a non-conducting liquid, and if no air bubbles occur from a sealed position where the drilled hole or opening that has been sealed with the sealant, the secondary battery is qualified. According to the present invention, the non-conducting liquid can be ethanol or glycerin. Alternatively, AOI equipment can be used to check the integrity of the shape of the sealant after it has dried and solidified to determine if it meets the standard required for sealing.

For the aforementioned drilling step and solution replenishing step, other approaches to the method for regenerating the secondary battery are proposed in the present invention and illustrated by the following examples.

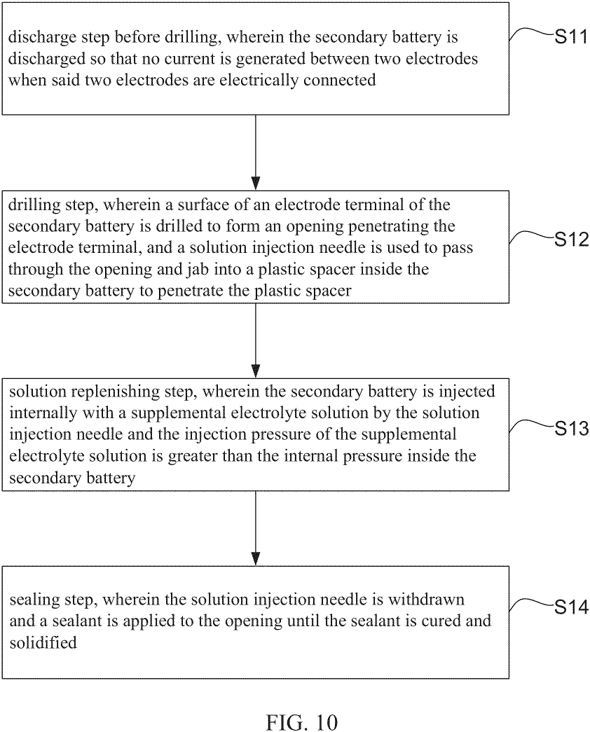

As shown in FIG. 10, FIG. 10 is a flow chart of a method for regenerating a secondary battery according to another embodiment of the present invention. In this method, the first step is a discharge step before drilling, wherein the secondary battery is discharged so that no current is generated between two electrodes when said two electrodes are electrically connected (S11). This step is the same as step S01 and will not be described in detail.

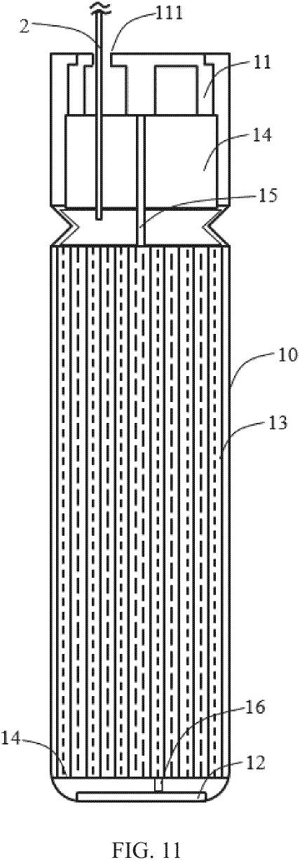

The second step of this method is a drilling step, wherein a surface of an electrode terminal of the secondary battery is drilled to form an opening penetrating the electrode terminal, and a solution injection needle is used to pass through the opening and jab into a spacer inside the secondary battery to penetrate the spacer (S12). For the convenience of illustration, the 18650 lithium-ion battery of FIG. 2 is still used herein as an example. As shown in FIG. 11, FIG. 11 is a schematic diagram of the drilling step according to the present method performed on the 18650 lithium-ion battery of FIG. 2. Unlike the drilling step in the previous embodiment, in the drilling step of the present embodiment, the drill bit 1 is only used to drill an opening 111 in the positive electrode terminal 11, and is then removed. Next, a solution injection needle 2, which has a much smaller diameter than the opening 111, is used to poke through the spacer 14, replacing the drilling action of the previous embodiment with the drill bit 1 drilling into the spacer 14. The advantage of this is that the solution injection needle 2 is convenient for replenishing the electrolyte solution directly into the 18650 lithium-ion battery and leaves a small gap that can be easily closed by squeezing, so there is no need to apply a sealant here. Of course, the drill bit 1 can also drill further into the spacer 14 for a certain distance to form a small cavity, so that the solution injection needle 2 can penetrate the spacer 14 more effortlessly, and this method is also within the application scope of the present invention. In addition, the small cavity formed by drilling into the spacer 14 with the aforementioned certain distance can also be sealed with sealant to ensure the integrity of the internal and external isolation.

The third step of this method is a solution replenishing step, wherein the secondary battery is injected internally with a supplemental electrolyte solution by the solution injection needle, and the injection pressure of the supplemental electrolyte solution injected is greater than the internal pressure inside the secondary battery (S13). This step is essentially the same as step S03 in the previous embodiment and will not be described in detail here.

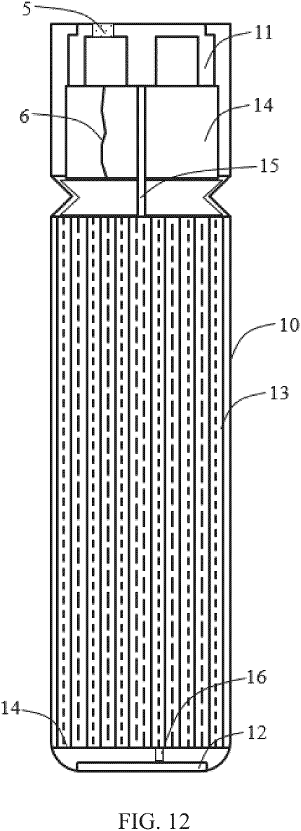

The fourth step of this method is a sealing step, wherein the solution injection needle is withdrawn and a sealant is applied to the opening until the sealant is cured and solidified (S14). As shown in FIG. 12, FIG. 12 is a schematic diagram of the solution replenishing step performed on the 18650 lithium-ion battery. After the solution injection needle 2 is withdrawn, the small gap 6 left by the solution injection needle 2 is closed by squeezing. Therefore, opening 111 can be sealed with sealant 5 as quickly as possible to complete the sealing step for the secondary battery. It is not necessary to apply a sealant to the small gap 6 since it is difficult to be done.

Certainly, in the present embodiment, the recharge step and the lithium dendrite removal and discharge step can be performed before the discharge step before drilling or after the sealing step. A testing step can also be added at the end to ensure quality.

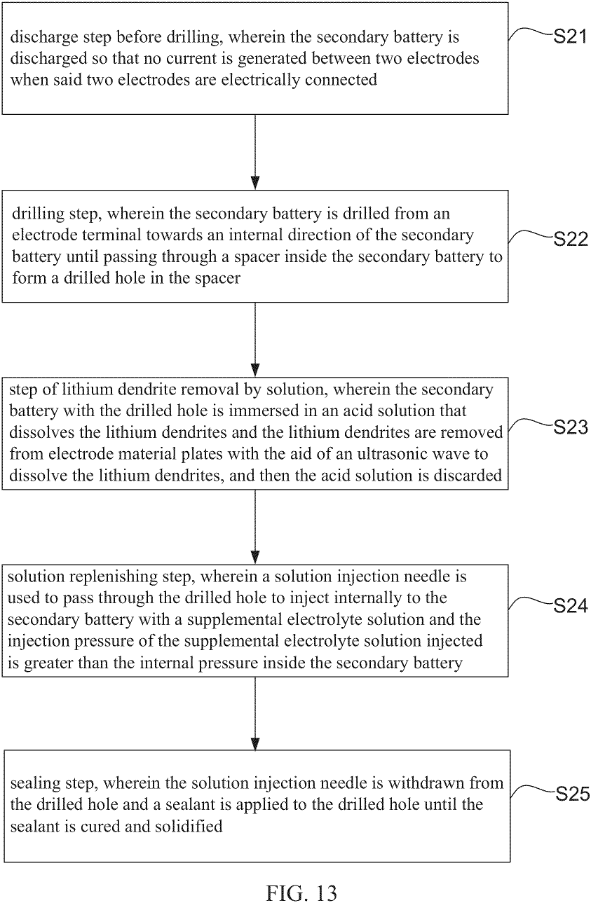

As shown in FIG. 13, in another embodiment of the method for regenerating a secondary battery according to the present invention, a step of lithium dendrite removal by solution (S23) may be added between the drilling step (S22) and the solution replenishing step (S24) to remove the lithium dendrites from the electrode material plates. The present embodiment comprises the following steps:
a discharge step before drilling (S21), wherein the secondary battery is discharged so that no current is generated between two electrodes when said two electrodes are electrically connected;
a drilling step (S22), wherein the secondary battery is drilled from an electrode terminal towards an internal direction of the secondary battery until passing through a spacer inside the secondary battery to form a drilled hole in the spacer;
a step of lithium dendrite removal by solution (S23), wherein the secondary battery with the drilled hole is immersed in an acid solution that dissolves the lithium dendrites and the lithium dendrites are removed from electrode material plates with the aid of an ultrasonic wave to dissolve the lithium dendrites, and then the acid solution is discarded;
a solution replenishing step (S24), wherein a solution injection needle is used to pass through the drilled hole to inject internally to the secondary battery with a supplemental electrolyte solution and the injection pressure of the supplemental electrolyte solution injected is greater than the internal pressure inside the secondary battery; and
a sealing step (S25), wherein the solution injection needle is withdrawn from the drilled hole and a sealant is applied to the drilled hole until the sealant is cured and solidified;
wherein the acid solution can be any acidic solution that can dissolve the lithium dendrites and will not damage the internal components of the battery;
wherein an impedance monitoring instrument can be used to monitor the internal impedance change of the battery at any time and an upper and lower limit value can be set;
wherein in the step of lithium dendrite removal by solution (S23), the cleaning time (i.e., the time to remove the lithium dendrites) is determined by the internal impedance data measured by the impedance monitoring instrument; and
wherein in the sealing step (S25), the drilled hole can be sealed with a hole plug so that the drilled hole can be reused next time in the step of lithium dendrite removal by solution for regenerating the secondary battery.

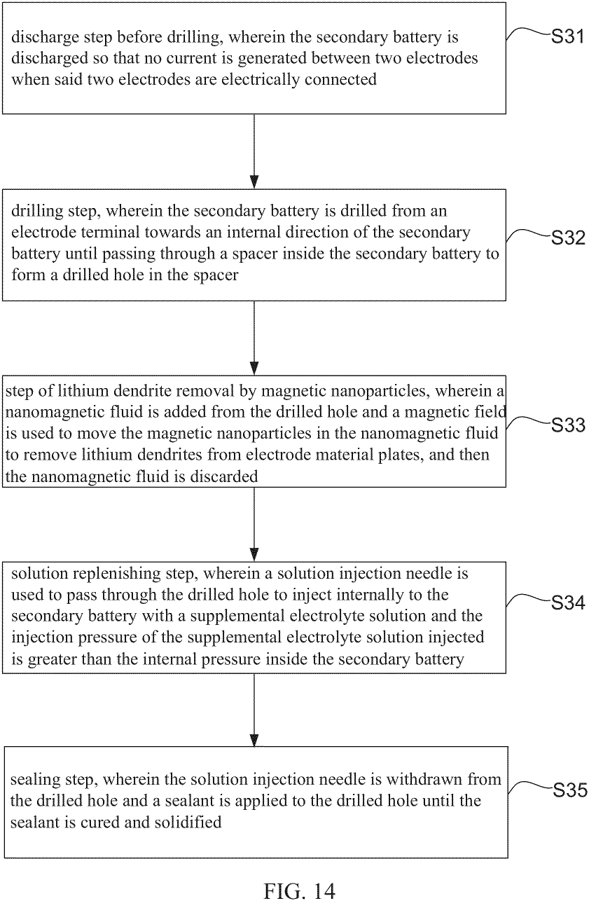

As shown in FIG. 14, in another embodiment of the method for regenerating a secondary battery according to the present invention, a step of lithium dendrite removal by magnetic nanoparticles (S33) may be added between the drilling step (S32) and the solution replenishing step (S34) to remove the lithium dendrites from the electrode material plates. The present embodiment comprises the following steps:
a discharge step before drilling (S31), wherein the secondary battery is discharged so that no current is generated between two electrodes when said two electrodes are electrically connected, and the discharge step before drilling can be performed at a temperature below zero degree;
a drilling step (S32), wherein the secondary battery is drilled from an electrode terminal towards an internal direction of the secondary battery until passing through a spacer inside the secondary battery to form a drilled hole in the spacer, wherein the spacer can be a plastic spacer or a metal spacer;
a step of lithium dendrite removal by magnetic nanoparticles (S33), wherein a nanomagnetic fluid is added from the drilled hole and a magnetic field is used to move the magnetic nanoparticles in the nanomagnetic fluid to remove lithium dendrites from electrode material plates, and then the nanomagnetic fluid is discarded;
a solution replenishing step (S34), wherein a solution injection needle is used to pass through the drilled hole to inject internally to the secondary battery with a supplemental electrolyte solution and the injection pressure of the supplemental electrolyte solution injected is greater than the internal pressure inside the secondary battery; and
a sealing step (S35), wherein the solution injection needle is withdrawn from the drilled hole and a sealant is applied to the drilled hole until the sealant is cured and solidified;
wherein the magnetic nanoparticles in the nanomagnetic fluid are moved up and down or right and left in the 3D space by means of a magnetic field and navigation of a line of the magnetic field to remove lithium dendrites, and the nanomagnetic fluid can be any nanomagnetic fluid that can remove lithium dendrites without damaging the internal components of the battery;
wherein in the sealing step (S35), the drilled hole can be sealed with a hole plug so that the drilled hole can be reused next time in the step of lithium dendrite removal by magnetic nanoparticles for regenerating the secondary battery; and
wherein in the step of lithium dendrite removal by magnetic nanoparticles (S33), an ultrasonic vibration may be used to assist in the removal of the lithium dendrites, or an ultrasonic vibration at a low-temperature supercritical state may be used to assist in the removal of the lithium dendrites.

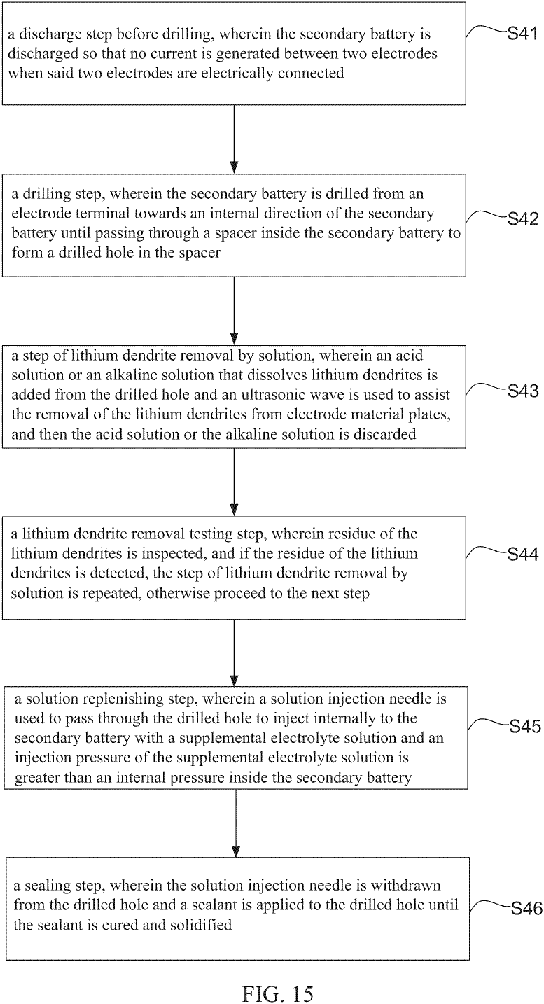

As shown in FIG. 15, the present invention provides an embodiment of a method for regenerating a secondary battery having a degraded electrical capacity of an electrolyte of lithium ions, and the method comprises
a discharge step before drilling (S41), wherein the secondary battery is discharged so that no current is generated between two electrodes when said two electrodes are electrically connected;
a drilling step (S42), wherein the secondary battery is drilled from an electrode terminal towards an internal direction of the secondary battery until passing through a spacer inside the secondary battery to form a drilled hole in the spacer;
a step of lithium dendrite removal by solution (S43), wherein an acid solution or an alkaline solution that dissolves lithium dendrites is added from the drilled hole and an ultrasonic wave is used to assist the removal of the lithium dendrites from electrode material plates, and then the acid solution or the alkaline solution is discarded;
a lithium dendrite removal testing step (S44), wherein residue of the lithium dendrites is inspected, and if the residue of the lithium dendrites is detected, the step of lithium dendrite removal by solution is repeated, otherwise proceed to the next step;
a solution replenishing step (S45), wherein a solution injection needle is used to pass through the drilled hole to inject internally to the secondary battery with a supplemental electrolyte solution and an injection pressure of the supplemental electrolyte solution is greater than an internal pressure inside the secondary battery; and
a sealing step (S46), wherein the solution injection needle is withdrawn from the drilled hole and a sealant is applied to the drilled hole until the sealant is cured and solidified;
wherein the secondary battery is activated after the sealing step (S46) is completed.

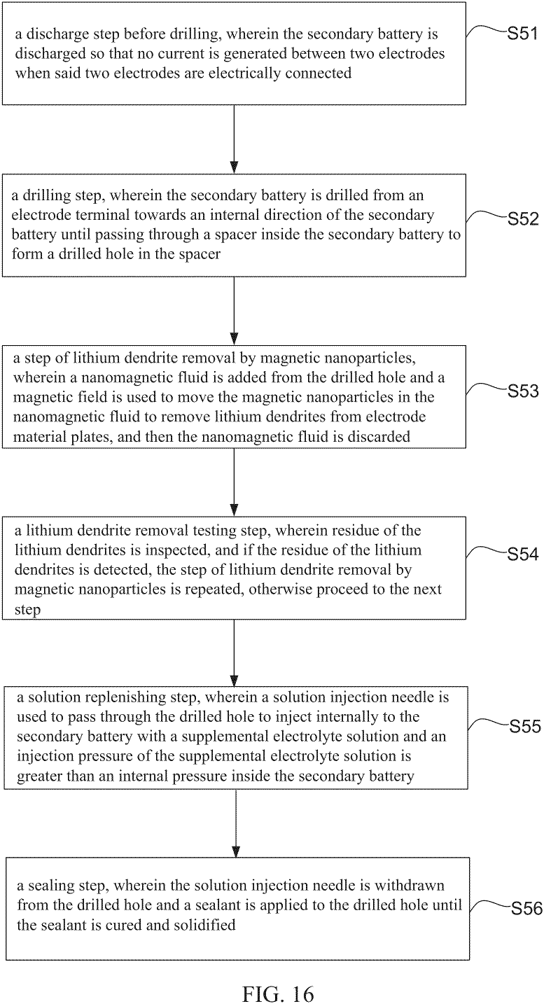

As shown in FIG. 16, the present invention provides an embodiment of a method for regenerating a secondary battery having a degraded electrical capacity of an electrolyte of lithium ions, and the method comprises
a discharge step before drilling (S51), wherein the secondary battery is discharged so that no current is generated between two electrodes when said two electrodes are electrically connected;
a drilling step (S52), wherein the secondary battery is drilled from an electrode terminal towards an internal direction of the secondary battery until passing through a spacer inside the secondary battery to form a drilled hole in the spacer;
a step of lithium dendrite removal by magnetic nanoparticles (S53), wherein a nanomagnetic fluid is added from the drilled hole and a magnetic field is used to move the magnetic nanoparticles in the nanomagnetic fluid to remove lithium dendrites from electrode material plates, and then the nanomagnetic fluid is discarded;
a lithium dendrite removal testing step (S54), wherein residue of the lithium dendrites is inspected, and if the residue of the lithium dendrites is detected, the step of lithium dendrite removal by magnetic nanoparticles is repeated, otherwise proceed to the next step;
a solution replenishing step (S55), wherein a solution injection needle is used to pass through the drilled hole to inject internally to the secondary battery with a supplemental electrolyte solution and an injection pressure of the supplemental electrolyte solution is greater than an internal pressure inside the secondary battery; and
a sealing step (S56), wherein the solution injection needle is withdrawn from the drilled hole and a sealant is applied to the drilled hole until the sealant is cured and solidified;
wherein the secondary battery is activated after the sealing step (S56) is completed.

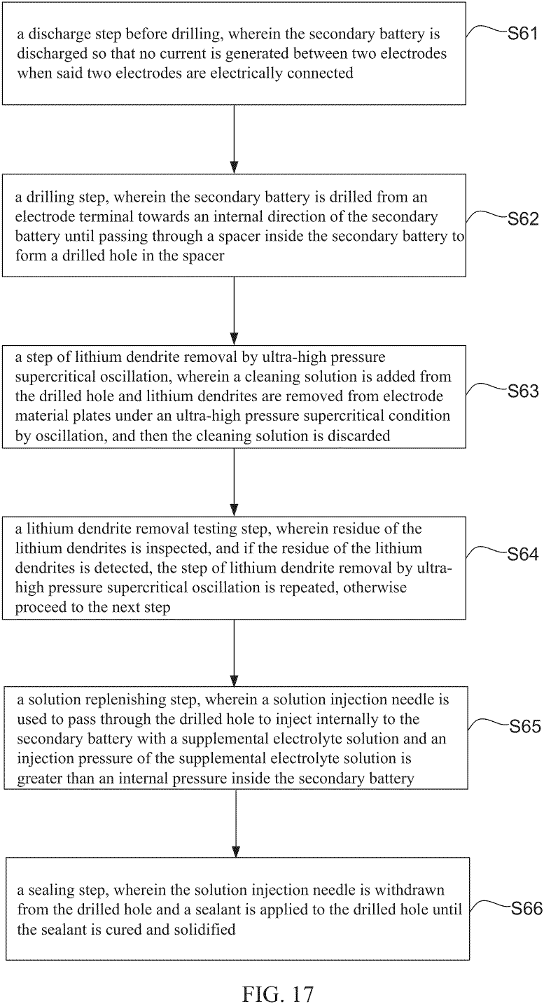

As shown in FIG. 17, the present invention provides an embodiment of a method for regenerating a secondary battery having a degraded electrical capacity of an electrolyte of lithium ions, and the method comprises
a discharge step before drilling (S61), wherein the secondary battery is discharged so that no current is generated between two electrodes when said two electrodes are electrically connected;
a drilling step (S62), wherein the secondary battery is drilled from an electrode terminal towards an internal direction of the secondary battery until passing through a spacer inside the secondary battery to form a drilled hole in the spacer;
a step of lithium dendrite removal by ultra-high pressure supercritical oscillation (S63), wherein a cleaning solution is added from the drilled hole and lithium dendrites are removed from electrode material plates under an ultra-high pressure supercritical condition by oscillation, and then the cleaning solution is discarded;
a lithium dendrite removal testing step (S64), wherein residue of the lithium dendrites is inspected, and if the residue of the lithium dendrites is detected, the step of lithium dendrite removal by ultra-high pressure supercritical oscillation is repeated, otherwise proceed to the next step;
a solution replenishing step (S65), wherein a solution injection needle is used to pass through the drilled hole to inject internally to the secondary battery with a supplemental electrolyte solution and an injection pressure of the supplemental electrolyte solution is greater than an internal pressure inside the secondary battery; and
a sealing step (S66), wherein the solution injection needle is withdrawn from the drilled hole and a sealant is applied to the drilled hole until the sealant is cured and solidified;
wherein the secondary battery is activated after the sealing step (S66) is completed.

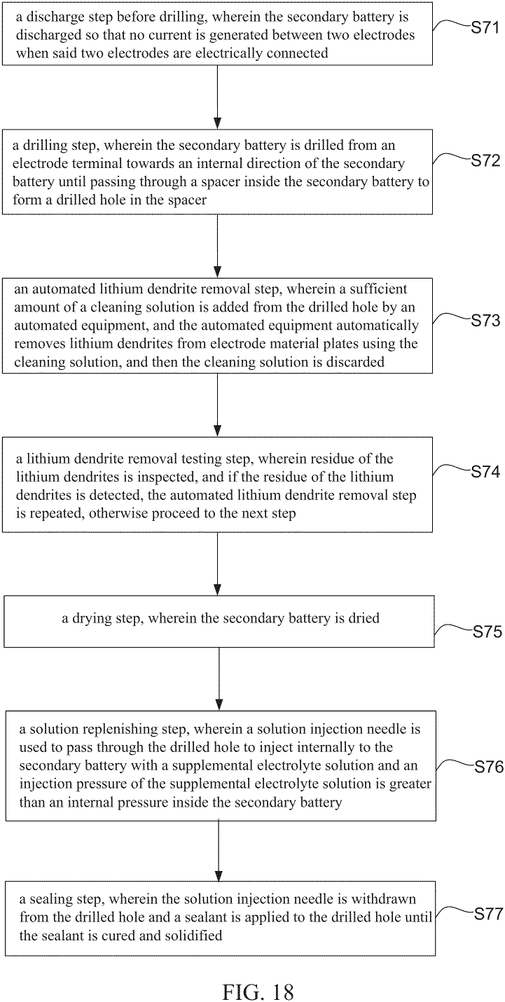

As shown in FIG. 18, the present invention provides an embodiment of a method for regenerating a secondary battery having a degraded electrical capacity of an electrolyte of lithium ions, and the method comprises
a discharge step before drilling (S71), wherein the secondary battery is discharged so that no current is generated between two electrodes when said two electrodes are electrically connected;
a drilling step (S72), wherein the secondary battery is drilled from an electrode terminal towards an internal direction of the secondary battery until passing through a spacer inside the secondary battery to form a drilled hole in the spacer;
an automated lithium dendrite removal step (S73), wherein a sufficient amount of a cleaning solution is added from the drilled hole by an automated equipment, and the automated equipment automatically removes lithium dendrites from electrode material plates using the cleaning solution, and then the cleaning solution is discarded;
a lithium dendrite removal testing step (S74), wherein residue of the lithium dendrites is inspected, and if the residue of the lithium dendrites is detected, the automated lithium dendrite removal step is repeated, otherwise proceed to the next step;
a drying step (S75), wherein the secondary battery is dried;
a solution replenishing step (S76), wherein a solution injection needle is used to pass through the drilled hole to inject internally to the secondary battery with a supplemental electrolyte solution and an injection pressure of the supplemental electrolyte solution is greater than an internal pressure inside the secondary battery; and
a sealing step (S77), wherein the solution injection needle is withdrawn from the drilled hole and a sealant is applied to the drilled hole until the sealant is cured and solidified;
wherein in the automated lithium dendrite removal step (S73), the automated equipment can be controlled by PCM to perform this step automatically in a timed, quantitative and qualitative manner;
wherein the secondary battery is activated after the sealing step (S77) is completed.

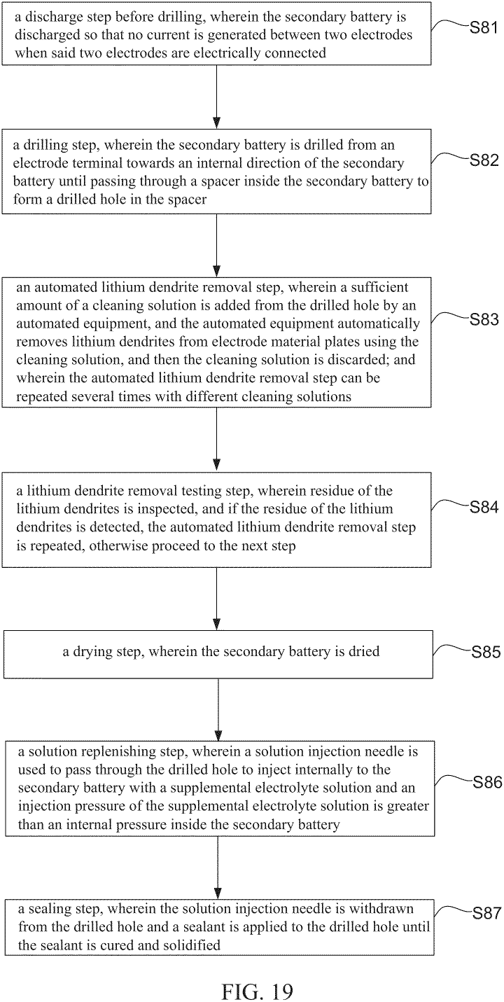

As shown in FIG. 19, the present invention provides an embodiment of a method for regenerating a secondary battery having a degraded electrical capacity of an electrolyte of lithium ions, and the method comprises
a discharge step before drilling (S81), wherein the secondary battery is discharged so that no current is generated between two electrodes when said two electrodes are electrically connected;
a drilling step (S82), wherein the secondary battery is drilled from an electrode terminal towards an internal direction of the secondary battery until passing through a spacer inside the secondary battery to form a drilled hole in the spacer;
an automated lithium dendrite removal step (S83), wherein a sufficient amount of a cleaning solution is added from the drilled hole by an automated equipment, and the automated equipment automatically removes lithium dendrites from electrode material plates using the cleaning solution, and then the cleaning solution is discarded; and wherein the automated lithium dendrite removal step can be repeated several times with different cleaning solutions (various chemical agents);
a lithium dendrite removal testing step (S84), wherein residue of the lithium dendrites is inspected, and if the residue of the lithium dendrites is detected, the automated lithium dendrite removal step is repeated, otherwise proceed to the next step;
a drying step (S85), wherein the secondary battery is dried;
a solution replenishing step (S86), wherein a solution injection needle is used to pass through the drilled hole to inject internally to the secondary battery with a supplemental electrolyte solution and an injection pressure of the supplemental electrolyte solution is greater than an internal pressure inside the secondary battery; and
a sealing step (S87), wherein the solution injection needle is withdrawn from the drilled hole and a sealant is applied to the drilled hole until the sealant is cured and solidified;
wherein the secondary battery is activated after the sealing step (S87) is completed.

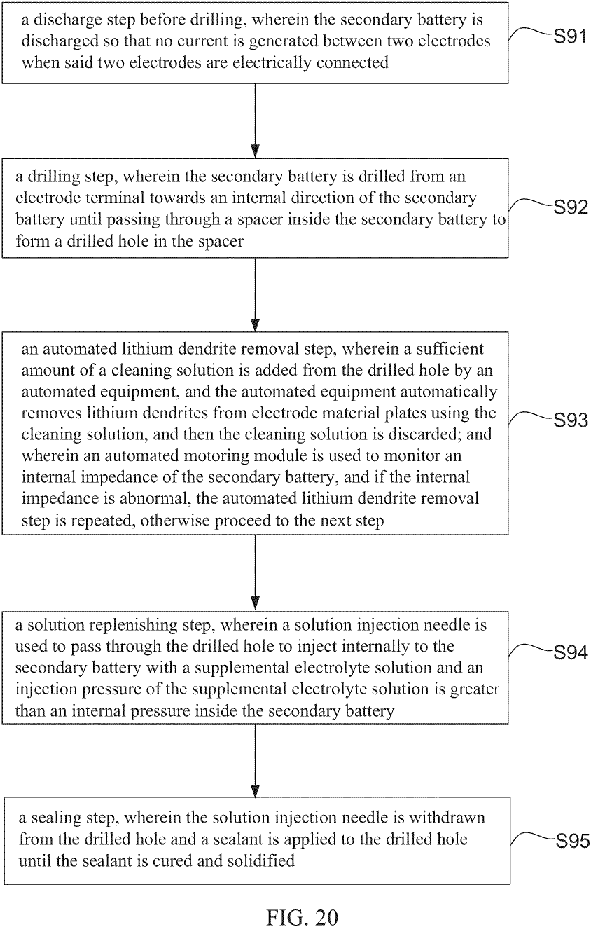

As shown in FIG. 20, the present invention provides an embodiment of a method for regenerating a secondary battery having a degraded electrical capacity of an electrolyte of lithium ions, and the method comprises
a discharge step before drilling (S91), wherein the secondary battery is discharged so that no current is generated between two electrodes when said two electrodes are electrically connected;
a drilling step (S92), wherein the secondary battery is drilled from an electrode terminal towards an internal direction of the secondary battery until passing through a spacer inside the secondary battery to form a drilled hole in the spacer;
an automated lithium dendrite removal step (S93), wherein a sufficient amount of a cleaning solution is added from the drilled hole by an automated equipment, and the automated equipment automatically removes lithium dendrites from electrode material plates using the cleaning solution, and then the cleaning solution is discarded; and wherein an automated motoring module is used to monitor an internal impedance of the secondary battery, and if the internal impedance is abnormal, the automated lithium dendrite removal step is repeated, otherwise proceed to the next step;
a solution replenishing step (S94), wherein a solution injection needle is used to pass through the drilled hole to inject internally to the secondary battery with a supplemental electrolyte solution and an injection pressure of the supplemental electrolyte solution is greater than an internal pressure inside the secondary battery; and
a sealing step (S95), wherein the solution injection needle is withdrawn from the drilled hole and a sealant is applied to the drilled hole until the sealant is cured and solidified;
wherein the automated motoring module can also monitor the change of pH value in the secondary battery or use the endoscope to automatically inspect the electrode material plates with AOI (Automated Optical Inspection) system;
wherein the secondary battery is activated after the sealing step (S95) is completed.

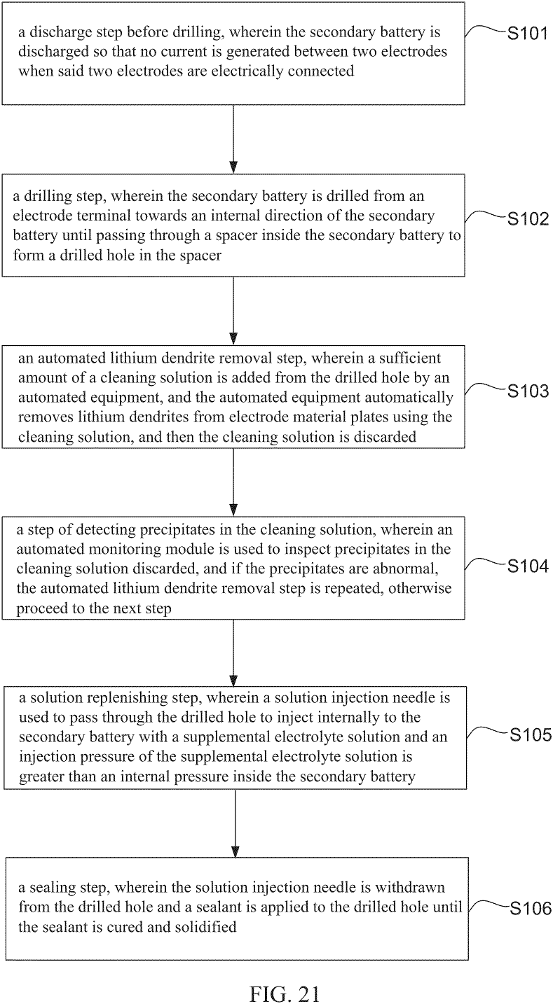

As shown in FIG. 21, the present invention provides an embodiment of a method for regenerating a secondary battery having a degraded electrical capacity of an electrolyte of lithium ions, and the method comprises
a discharge step before drilling (S101), wherein the secondary battery is discharged so that no current is generated between two electrodes when said two electrodes are electrically connected;
a drilling step (S102), wherein the secondary battery is drilled from an electrode terminal towards an internal direction of the secondary battery until passing through a spacer inside the secondary battery to form a drilled hole in the spacer;
an automated lithium dendrite removal step (S103), wherein a sufficient amount of a cleaning solution is added from the drilled hole by an automated equipment, and the automated equipment automatically removes lithium dendrites from electrode material plates using the cleaning solution, and then the cleaning solution is discarded;
a step of detecting precipitates in the cleaning solution (S104), wherein an automated monitoring module is used to inspect precipitates in the cleaning solution discarded, and if the precipitates are abnormal, the automated lithium dendrite removal step is repeated, otherwise proceed to the next step;
a solution replenishing step (S105), wherein a solution injection needle is used to pass through the drilled hole to inject internally to the secondary battery with a supplemental electrolyte solution and an injection pressure of the supplemental electrolyte solution is greater than an internal pressure inside the secondary battery; and
a sealing step (S106), wherein the solution injection needle is withdrawn from the drilled hole and a sealant is applied to the drilled hole until the sealant is cured and solidified;
wherein in the step of detecting precipitates in the cleaning solution (S104), the precipitate detected is lithium sulfate;
wherein the secondary battery is activated after the sealing step (S 106) is completed.

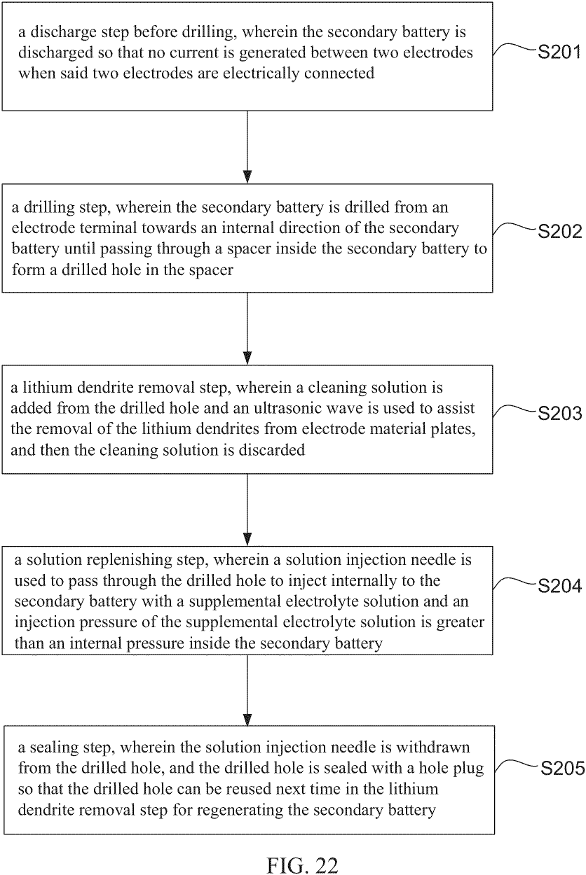

As shown in FIG. 22, the present invention provides an embodiment of a method for regenerating a secondary battery having a degraded electrical capacity of an electrolyte of lithium ions, and the method comprises
a discharge step before drilling (S201), wherein the secondary battery is discharged so that no current is generated between two electrodes when said two electrodes are electrically connected;
a drilling step (S202), wherein the secondary battery is drilled from an electrode terminal towards an internal direction of the secondary battery until passing through a spacer inside the secondary battery to form a drilled hole in the spacer;
a lithium dendrite removal step (S203), wherein a cleaning solution is added from the drilled hole and an ultrasonic wave is used to assist the removal of the lithium dendrites from electrode material plates, and then the cleaning solution is discarded;
a solution replenishing step (S204), wherein a solution injection needle is used to pass through the drilled hole to inject internally to the secondary battery with a supplemental electrolyte solution and an injection pressure of the supplemental electrolyte solution is greater than an internal pressure inside the secondary battery; and
a sealing step (S205), wherein the solution injection needle is withdrawn from the drilled hole, and the drilled hole is sealed with a hole plug so that the drilled hole can be reused next time in the lithium dendrite removal step for regenerating the secondary battery;
wherein in the lithium dendrite removal step (S203), the cleaning solution can also be automatically added by an automated equipment, and the removal of the lithium dendrites can be assisted by ultrasonic wave or ultra-high pressure or supercritical or ultra-high temperature steam equipment;
wherein the secondary battery is activated after the sealing step (S205) is completed.

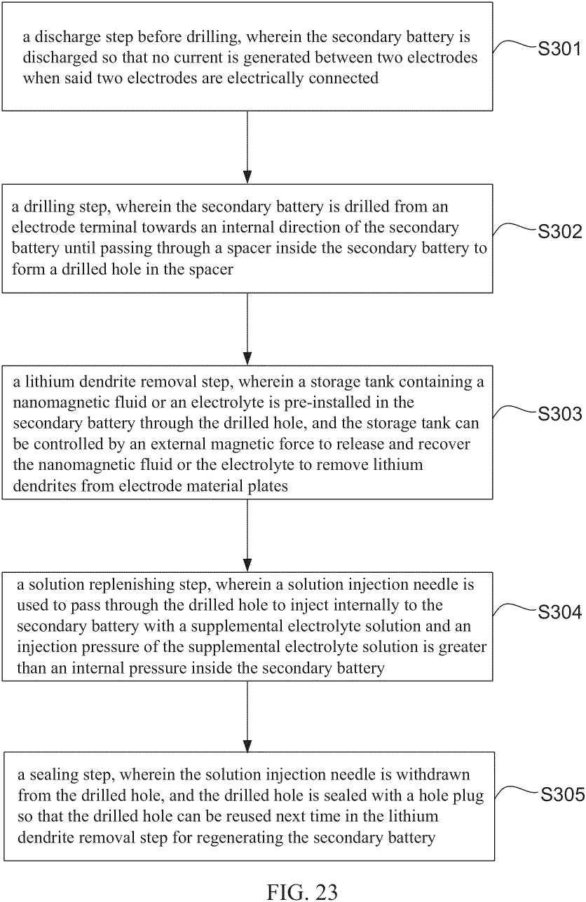

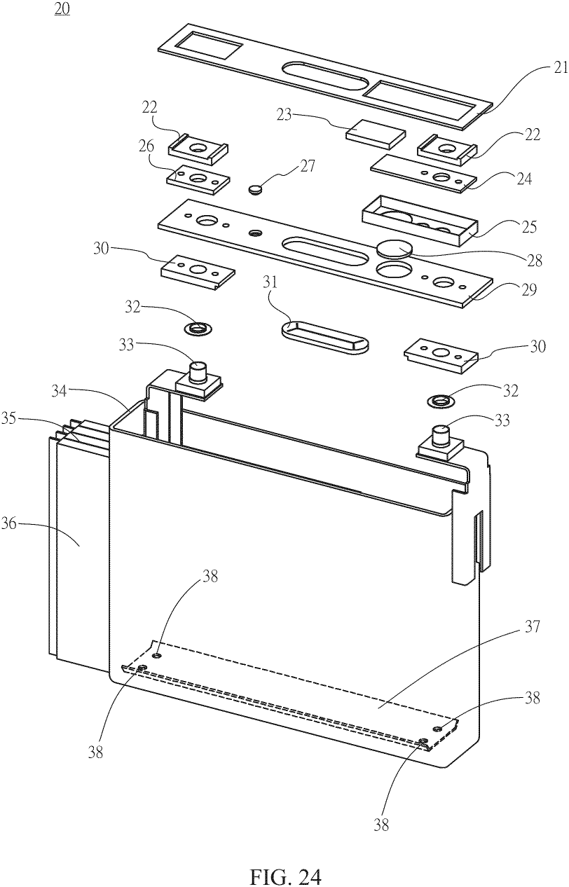

As shown in FIG. 23, the present invention provides an embodiment of a method for regenerating a secondary battery having a degraded electrical capacity of an electrolyte of lithium ions, and the method comprises
a discharge step before drilling (S301), wherein the secondary battery is discharged so that no current is generated between two electrodes when said two electrodes are electrically connected;
a drilling step (S302), wherein the secondary battery is drilled from an electrode terminal towards an internal direction of the secondary battery until passing through a spacer inside the secondary battery to form a drilled hole in the spacer;
a lithium dendrite removal step (S303), wherein a storage tank containing a nanomagnetic fluid or an electrolyte is pre-installed in the secondary battery through the drilled hole, and the storage tank can be controlled by an external magnetic force to release and recover the nanomagnetic fluid or the electrolyte to remove lithium dendrites from electrode material plates;
a solution replenishing step (S304), wherein a solution injection needle is used to pass through the drilled hole to inject internally to the secondary battery with a supplemental electrolyte solution and an injection pressure of the supplemental electrolyte solution is greater than an internal pressure inside the secondary battery; and
a sealing step (S305), wherein the solution injection needle is withdrawn from the drilled hole, and the drilled hole is sealed with a hole plug so that the drilled hole can be reused next time in the lithium dendrite removal step for regenerating the secondary battery;
wherein when the drilled hole is sealed with the hole plug, the storage tank can again release and recover the nanomagnetic fluid or the electrolyte by the control of the external magnetic force to remove lithium dendrites from the electrode material plates;
wherein in the lithium dendrite removal step (S303), when the electrolyte is released, the electrolyte may be assisted by an ultrasonic wave to remove the lithium dendrites from the electrode material plates;
wherein the secondary battery is activated after the sealing step (S305) is completed.

FIG. 24 is an exploded view of a square lithium battery 20, which includes: cap plate cover 21, terminal plates 22, top insulator cover 23, connection plate 24, top insulator 25, top plate 26, seal pin 27, OSD (Overcharge Safety Device) membrane 28, cap plate 29, bottom insulators 30, safety vent 31, seal gaskets 32, rivet type terminals 33, can 34, jelly roll 35, NSD (Nail Safety Device) 36, and bottom retainer 37. The above-mentioned methods for regenerating a secondary battery according to the present invention can also be applied to the square lithium battery 20 by configuring a drilled hole in the rivet type terminal 33 and providing a hole plug in the drilled hole to seal it, so that the square lithium battery 20 can be repeatedly filled with supplemental electrolyte solution through the drilled hole. Alternatively, connection plate 24 can be modified into a removable connection plate, and then the OSD membrane 28 and the safety vent 31 can be opened for replenishing the square lithium battery 20 with the supplemental electrolyte solution. Furthermore, a storage tank (not shown) can also be pre-configured in the bottom retainer 37, which contains the electrolyte, and the electrolyte can be released into the square lithium battery 20 through externally controlled hole valves 38.

Although the present invention has been disclosed as the above embodiments, the above embodiments are not intended to limit the present invention. Any person with ordinary knowledge in the field can make changes and modifications without departing from the spirit and scope of the present invention. Therefore, the scope of the present invention is defined by the appended claims.

What is claimed is:

1. A method for regenerating a secondary battery having a degraded electrical capacity of an electrolyte of lithium ions, comprising
a discharge step before drilling, wherein the secondary battery is discharged so that no current is generated between two electrodes when said two electrodes are electrically connected;
a drilling step, wherein the secondary battery is drilled from an electrode terminal towards an internal direction of the secondary battery until passing through a spacer inside the secondary battery to form a drilled hole in the spacer;
a solution replenishing step, wherein a solution injection needle is used to pass through the drilled hole to inject internally to the secondary battery with a supplemental electrolyte solution and an injection pressure of the supplemental electrolyte solution is greater than an internal pressure inside the secondary battery; and
a sealing step, wherein the solution injection needle is withdrawn from the drilled hole and a sealant is applied to the drilled hole until the sealant is cured and solidified.

2. The method of claim 1, wherein before the discharge step before drilling or after the sealing step, the method further comprises:
a recharge step, wherein the secondary battery is charged in a manner of a gradually decreasing electric current and a continuous or intermittent high current is applied to the secondary battery at a time of initial charging and before completion of charging to remove lithium dendrites from electrode material plates for a first time; and
a lithium dendrite removal and discharge step, wherein the secondary battery is discharged in a manner of a gradually increasing electric current and the secondary battery is discharged by a continuous or intermittent high current at a time of initial discharging and before completion of discharging to remove lithium dendrites from the electrode material plates for a second time.

3. The method of claim 1, wherein the drilling step and the solution replenishing step are performed in a vacuum environment and the solution injection needle isolates the supplemental electrolyte solution and internal materials of the secondary battery from the vacuum environment outside.

4. The method of claim 1, wherein the method further comprises a testing step, wherein the secondary battery is placed in a non-conducting liquid, and if no air bubbles occur from a sealed position where the drilled hole that has been sealed with the sealant, the secondary battery is qualified.

5. The method of claim 2, wherein the high current is less than 1000 times an electric current when the secondary battery is discharged or charged.

6. The method of claim 2, wherein the intermittent high current forms a pulse current.

7. The method of claim 1, wherein the drilling step is performed by simultaneously sucking or blowing powder particles generated out of the drilled hole.

8. The method of claim 1, wherein the sealing step further uses a glue syringe to apply the sealant to the drilled hole.

9. A method for regenerating a secondary battery having a degraded electrical capacity of an electrolyte of lithium ions, comprising
a discharge step before drilling, wherein the secondary battery is discharged so that no current is generated between two electrodes when said two electrodes are electrically connected;
a drilling step, wherein a surface of an electrode terminal of the secondary battery is drilled to form an opening penetrating the electrode terminal, and a solution injection needle is used to pass through the opening and jab into a spacer inside the secondary battery to penetrate the spacer;
a solution replenishing step, wherein the secondary battery is injected internally with a supplemental electrolyte solution by the solution injection needle and an injection pressure of the supplemental electrolyte solution is greater than an internal pressure inside the secondary battery; and
a sealing step, wherein the solution injection needle is withdrawn and a sealant is applied to the opening until the sealant is cured and solidified.

10. The method of claim 9, wherein before the discharge step before drilling or after the sealing step, the method further comprises:
a recharge step, wherein the secondary battery is charged in a manner of a gradually decreasing electric current and a continuous or intermittent high current is applied to the secondary battery at a time of initial charging and before completion of charging to remove lithium dendrites from electrode material plates for a first time; and
a lithium dendrite removal and discharge step, wherein the secondary battery is discharged in a manner of a gradually increasing electric current and the secondary battery is discharged by a continuous or intermittent high current at a time of initial discharging and before completion of discharging to remove lithium dendrites from the electrode material plates for a second time.

11. The method of claim 9, wherein the drilling step and the solution replenishing step are performed in a vacuum environment and the solution injection needle isolates the supplemental electrolyte solution and internal materials of the secondary battery from the vacuum environment outside.

12. The method of claim 9, wherein the method further comprises a testing step, wherein the secondary battery is placed in a non-conducting liquid, and if no air bubbles occur from a sealed position where the opening that has been sealed with the sealant, the secondary battery is qualified.

13. The method of claim 10, wherein the high current is less than 1000 times an electric current when the secondary battery is discharged or charged.

14. The method of claim 10, wherein the intermittent high current forms a pulse current.

15. The method of claim 9, wherein the drilling step is performed by simultaneously sucking or blowing powder particles generated out of the opening.

16. The method of claim 9, wherein the sealing step further uses a glue syringe to apply the sealant to the opening.
